(19) United States
(12) Patent Application Publication
(10) Pub. No.: US 2002/0101426 A1
(43) Pub. Date: Aug. 1, 2002

(54) Information display method

(75) Inventor: Junichi Okamura, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: PIONEER CORPORATION

(21) Appl. No.: 10/059,351

(22) Filed: Jan. 31, 2002

(30) Foreign Application Priority Data
Jan. 31, 2001 (JP) P2001-022847

(51) Int. Cl. G06T 1/60

(52) U.S. Cl. 345/530

(57) ABSTRACT

A map data memory area for storing map data read from external is set in a hard disk of an information terminal, the map information read from external is stored in the map data memory area, if the information terminal is requested to display a map image, whether or not the map data requested to be displayed is stored in the map data memory area is retrieved, if the map data requested to be displayed is stored in the map data memory area, the map data stored in the map data memory area is read and is displayed on the information terminal, and if the map data requested to be displayed is not stored in the map data memory area, the map data to be displayed is read from external and is displayed on the information terminal, and the read map data is stored in the map data memory area.

### BACKGROUND OF THE INVENTION

1. Field of the Invention

This invention relates to a method of displaying information read from external into an information terminal.

2. Description of the Related Art

In recent years, information providing service for providing various pieces of information (contents) using computer networks of the Internet, an intra-company network system (intranet), etc., has been rapidly enriched with the widespread use of information terminals of microcomputers, etc.

Such information providing service includes, for example, map information providing service for providing a user's information terminal with user-desired map data through a computer network.

In the map information providing service, when the user enters information specifying an address, a facility name, etc., in the information terminal, a database server retrieves a map image corresponding to the specification information entered by the user from a map database previously storing data of map images and provides the user's information terminal with the data file of the retrieved map image through the Internet.

FIG. 4 shows a map information providing system using the Internet in a related art for conducting map information providing service as described above.

In FIG. 4, S1′ denotes a map information providing site managed by an enterprise, etc., for providing map information for the user, and S2′ denotes a map database site for collectively conducting map information providing service.

The map information providing site S1′ and the map database site S2′ are connected to Internet I and an information terminal T accesses the Internet I via a public telephone network (not shown) and an access server (not shown), whereby the information terminal T is connected to the map information providing site S1′ and the map database site S2′.

The map information providing site S1′ comprises a WWW server S1a′ for displaying a WWW page to provide the information terminal T of the user with map information and a position information database S1b′ storing position data indicating the coordinates on a map (latitudes and longitudes) corresponding to addresses, facility names, telephone numbers, etc.

The map database site S2′ comprises a map server S2a′ for retrieving a map image and providing the information terminal T with data file of the retrieved map image, a map information database S2b′ storing map image data, and a retrieval database S2c′ storing retrieval data indicating the correspondence between the map image data stored in the map information database S2b′ and the position data indicating the coordinates on a map.

The information terminal T is a user terminal and can receive WWW service by using an application program called a WWW browser.

In the described map information providing system, when the user accesses the map information providing site S1′ through the Internet I from the information terminal T by specifying the URL (Uniform Resource Locator) of the map information providing site S1′ and enters specification information of the address, the facility name, etc., to get any desired map image on the displayed WWW page, the WWW server S1a′ in the map information providing site S1′ collates the character string, etc., of the address entered with the position information database S1b′, reads the corresponding position data, and transmits the position data to the information terminal T.

The position data is transmitted from the information terminal T to the map database site S2′.

The map server S2a′ in the map database site S2′ collates the transmitted position data with the retrieval database S2c′, reads the corresponding map image data from the map information database S2b′, and transmits the data file of the map image data to the information terminal T, whereby the map image is displayed on the information terminal T.

Information is also provided by an almost similar method in information providing service for providing various pieces of information in addition to the map data providing service as described above.

For the user to use such information providing service to display information on the information terminal T, if the user attempts to move the center position of the display image up and down or from side to side or attempts to change the image, for example, by performing operation of scrolling, etc., generally the information terminal T recognizes the displayed image and the post-scrolled or post-changed image as separate images and thus an image data transmission request is sent from the information terminal T to the information providing site providing the image and a new image is displayed.

However, in the information display method in the related art as described above, it takes time until a new image is displayed as the operation of scrolling, etc., is performed, and smooth image change cannot be performed; this is a problem.

In the information terminal T in the related art, the data file downloaded from the information providing site is temporarily stored in cache memory and the data files stored in the cache memory are automatically deleted in the date order starting at the oldest data file as new write is conducted. Thus, if the user attempts to display the same image, it becomes necessary to again download the same data file from the information providing site and the communication cost, time, labor, and the like are spent duplicately; this is a problem.

The invention is intended to solve the problems in the related art when displaying information read from external into a user's information terminal as described above.

It is therefore an object of the invention to provide an information display method capable of making effective use of information provided by information providing service, smoothly displaying an image on a user's information terminal, and improving efficiency for again displaying the same information.

### SUMMARY OF THE INVENTION

To the end, according to a first aspect of the invention, there is provided a method of displaying information read from external in an information terminal, the method comprising the steps of: setting a storage area of information read from external in a storage section of the information terminal; storing the information read from external in the information storage area; when the information terminal is requested to display information, determining whether or not the information requested to be displayed is stored in the information storage area; when the information requested to be displayed is stored in the information storage area, reading the information stored in the information storage area to display the information on the information terminal; and when the information requested to be displayed is not stored in the information storage area, reading the information to be displayed from external to display the information read from external on the information terminal and to store the information read from external in the information storage area.

The information display method according to the first aspect of the invention is applied, for example, when the user accesses various information providing sites of a map information providing site, etc., from an information terminal through a computer network of the Internet, an intranet, etc., for displaying information of a map image, etc., on the display of the information terminal based on the information provided from the information providing site.

That is, if a program for executing the information display method according to the invention is set in the information terminal, an information storage area for storing the information read from external is set in a storage medium of the information terminal.

If the user performs a predetermined entry operation of specifying the information to be displayed, etc., for the information terminal, a CPU of the information terminal determines whether or not the information to be displayed, specified by the user is stored in the information storage area set in the storage medium of the information terminal based on the above-mentioned program. If the CPU determines that the information is stored in the information storage area, the CPU reads the information from the information storage area instead of downloading the information from the information providing site connected through the computer network, and displays the read information on the information terminal.

If the CPU determines that the information requested to be displayed is not stored in the information storage area, the CPU downloads the information from the information providing site connected through the computer network, stores the downloaded information in the information storage area of the information terminal, and displays the information on the information terminal.

When the user again makes a request to display the information, the information stored in the information storage area is read from the information storage area and is displayed on the information terminal.

In case of displaying information read from an external storage medium of CD-ROM, etc., on the information terminal, the information read from the external storage medium is also stored in the information storage area and when a request to display the information is again made, the information is read from the information storage area and is displayed.

As described above, according to the first aspect of the invention, the information read into the information terminal for display is stored in the information storage area set in the information terminal, and is reused when a request to display the information is again made, so that the need for again reading the information to be displayed into the information terminal is eliminated, the information is displayed rapidly, image display is also produced smoothly as the scroll operation is performed, and it is made possible to reduce the communication cost formerly required for the information downloaded through the computer network.

In the information display method according to a second aspect of the invention, to accomplish the above-mentioned object, in addition to the configuration of the first aspect of the invention, the information stored in the information storage area is information provided from an information providing site connected to the information terminal through a computer network.

According to the information display method according to the second aspect of the invention, when the information terminal is connected through the computer network to the information providing site for providing various pieces of information such as map data and displays the information downloaded from the information providing site, the downloaded information is stored in the information storage area of the information terminal.

When a request to display the same information is made, the information stored in the information storage area of the information terminal is read for display.

In the information display method according to a third aspect of the invention, to accomplish the above-mentioned object, in addition to the configuration of the first aspect of the invention, the information stored in the information storage area is information read from a storage medium.

According to the information display method according to the third aspect of the invention, when information is loaded into the information terminal from a record medium such as a CD-ROM or the like recording various pieces of information such as map data and is displayed, the information loaded from the record medium is stored in the information storage area of the information terminal.

When a request to display the same information is made, the information stored in the information storage area of the information terminal is read for display.

In the information display method according to a fourth aspect of the invention, to accomplish the above-mentioned object, in addition to the configuration of the first aspect of the invention, the information is stored in the information storage area together with date data indicating the storage date.

According to the information display method according to the fourth aspect of the invention, when the information stored in the information storage area is updated, it is updated to the most recent information based on the date data given when the information was stored.

In the information display method according to a fifth aspect of the invention, to accomplish the above-mentioned object, in addition to the configuration of the first aspect of the invention, the information stored in the information storage area is updated to one of information provided from an information providing site connected to the information terminal through a computer network and information read from a storage medium.

According to the information display method according to the fifth aspect of the invention, the information stored in the information storage area, which is downloaded from the information providing site connected through the computer network or is loaded from the storage medium of CD-ROM, etc., is updated to the most recent information downloaded from the information providing site by the updating operation of the user or by automatic updating set by the user or loaded from the storage medium of CD-ROM, etc.

In the information display method according to a sixth aspect of the invention, to accomplish the above-mentioned object, in addition to the configuration of the first aspect of the invention, the information stored in the information storage area is map data to display a map image.

According to the information display method according to the sixth aspect of the invention, when the information terminal is connected through the computer network to a map data providing site for providing map data and displays a map image based on the map data downloaded from the map data providing site or the information terminal displays a map image based on the map data loaded from the record medium of CD-ROM, etc., the map data downloaded from the map data providing site or the map data loaded from the record medium of CD-ROM, etc., is stored in the information storage area of the information terminal.

When a request to display the same map image is made, the map data stored in the information storage area of the information terminal is read for display.

### BRIEF DESCRIPTION OF THE DRAWINGS

FIG. 1 is a system configuration diagram to show an example of a map information providing system using a computer network wherein an information display method according to the invention is executed.

FIG. 2 is a flowchart to show a procedure for storing information in one embodiment of the invention.

FIG. 3 is a flowchart to show a procedure for displaying information in the embodiment of the invention.

FIG. 4 is a system configuration diagram to show a map information providing system using a computer network in a related art.

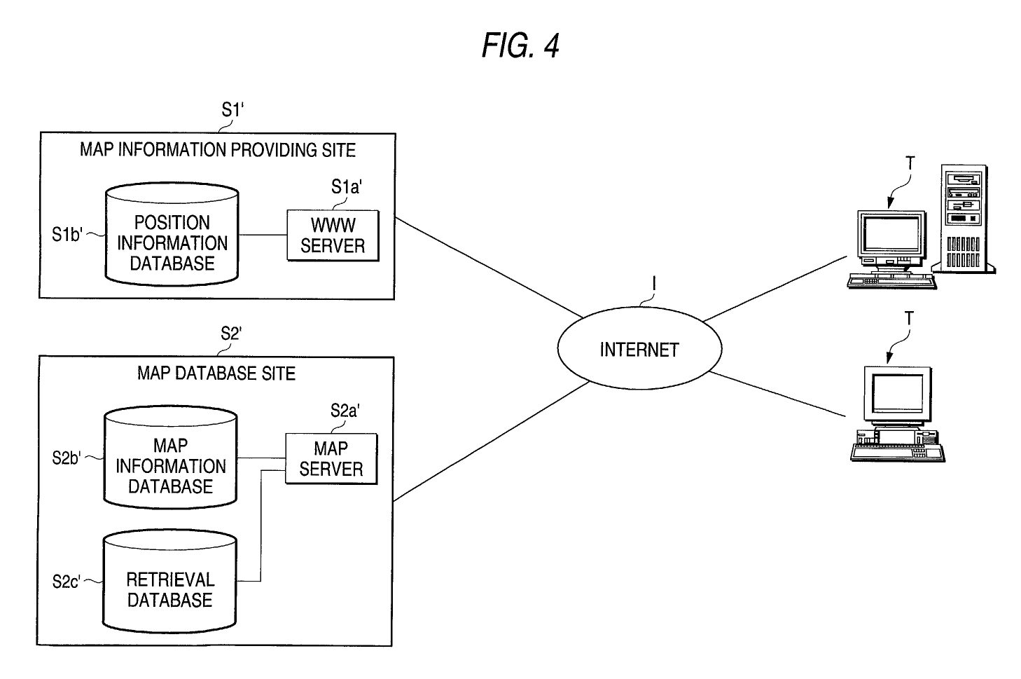

### DETAILED DESCRIPTION OF THE PREFERRED EMBODIMENTS

Referring now to the accompanying drawings, a preferred embodiment of the invention will be described in detail.

An information display method according to the invention can be applied to all information (contents) provided through a computer network. In the description that follows, a case of displaying a map image on a user's information terminal based on map data provided from a map database site is taken as an example.

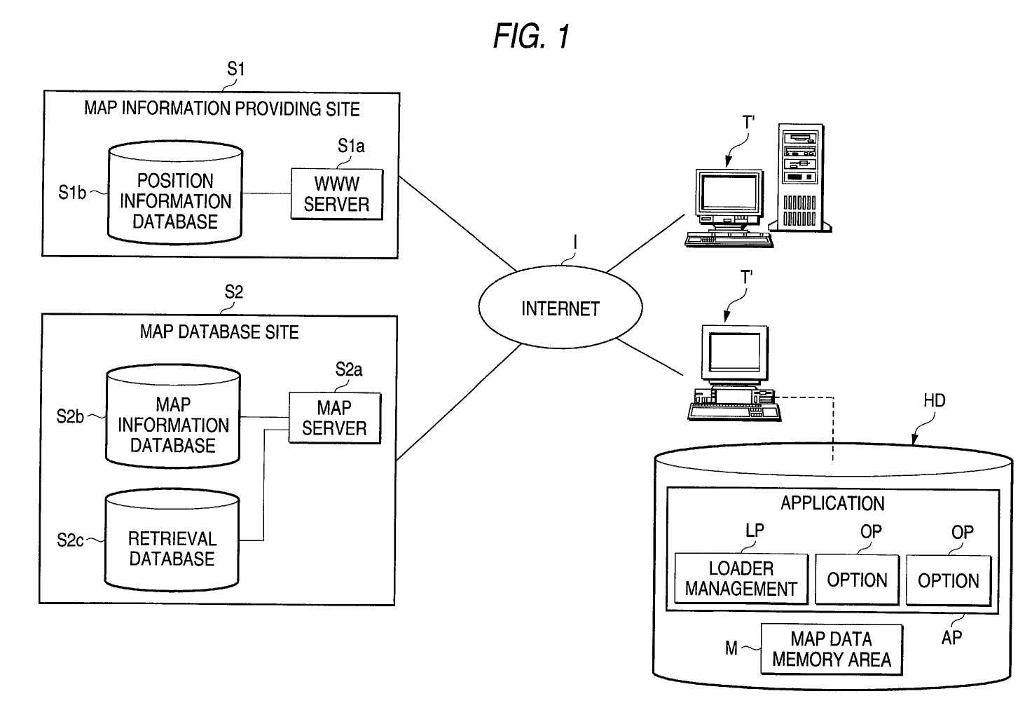

FIG. 1 is a system configuration diagram to show an example of a map information providing system. An information terminal T′ connected to the Internet I receives map data transmitted from a map information providing site S1 and a map database site S2 and displays a map image.

In the information terminal T′, a loader management program LP for executing the information display method according to the invention is built in an application program AP for displaying a map image based on the transmitted map data.

The application program AP includes various optional programs such as a route calculation program, an electronic mail program, and a program for pasting any other information of a document, a drawing, etc., on a map.

When the loader management program LP is installed in the information terminal T together with the application program AP, the loader management program LP sets a map data memory area M for storing downloaded map data in a hard disk of the information terminal T.

The map data downloaded through the Internet I from the map information providing site S1 and the map database site S2 is written into the map data memory area M for storage, as described later.

The map data loaded from a record medium such as CD-ROM is also written into the map data memory area M for storage.

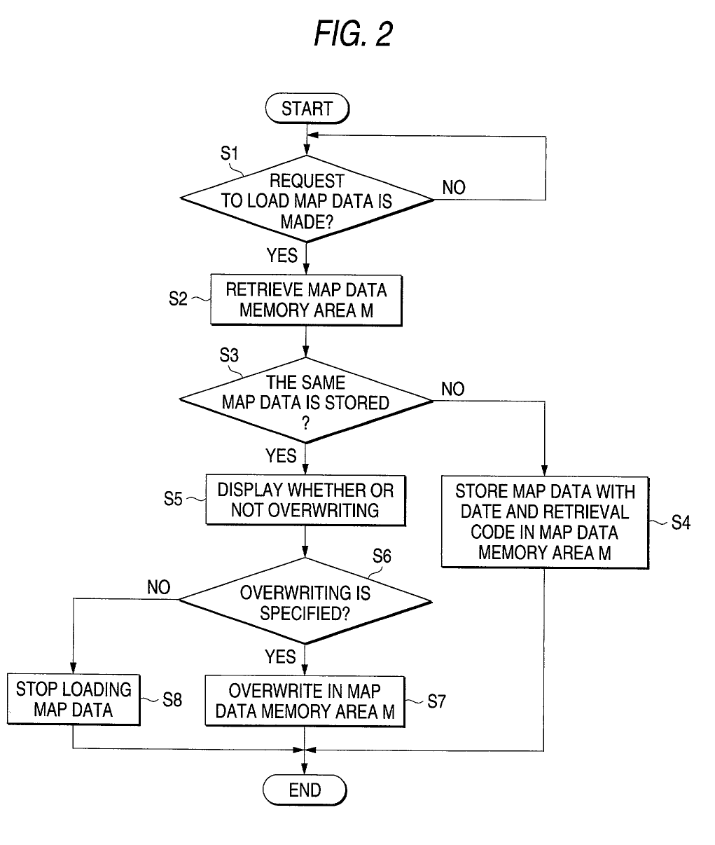

Next, a procedure of storing the map data in the map data memory area M executed by the loader management program LP will be discussed based on a flowchart shown in FIG. 2.

In FIG. 2, a CPU of the information terminal T determines whether or not the user makes a request to load map data (including both downloading map data through the Internet I and loading map data from CD-ROM) based on the loader management program LP (step s1) . If the user makes a request to load map data, then the CPU retrieves map data in the map data memory area M in the hard disk HD (step s2).

Next, the CPU determines whether or not the map data requested to be loaded is already stored in the map data memory area M based on the retrieval result at step s2 (step s3).

If the CPU determines at step s3 that the same data as the map data requested to be loaded is not stored in the map data memory area M, the CPU loads the requested map data through the Internet I or from CD-ROM and stores the map data in the map data memory area M together with load date and a retrieval code (step s4).

At this time, the image of the map data loaded may be displayed on the information terminal T′ and be stored in the map data memory area M after the user acknowledges the image of the map data.

If it is determined at step s3 that the map data requested to be loaded is stored in the map data memory area M, the data is already stored and thus the CPU displays a message for requesting the user to specify whether or not the already stored map data is to be overwritten (step s5).

The CPU determines whether or not the user specifies overwriting the already stored map data (step s6). If the user specifies overwriting the already stored map data, the CPU loads the requested map data and overwrites the already stored map data in the map data memory area M with the loaded map data together with the load date and the retrieval code (step s7).

If the CPU determines at step s6 that the user does not specify overwriting the already stored map data, the CPU stops loading the requested map data (step s8).

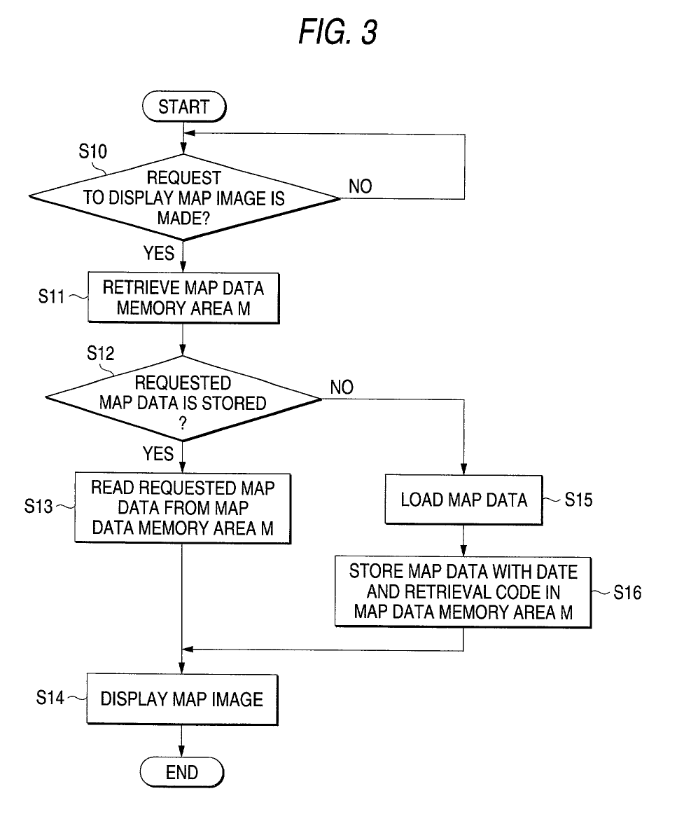

Next, a procedure for displaying a map image, executed by the loader management program LP will be discussed based on a flowchart shown in FIG. 3.

In FIG. 3, the CPU of the information terminal T′ determines whether or not the user makes a request to display a map image based on the loader management program LP (step s10). If the user makes a request to display a map image, then the CPU retrieves the map data corresponding to the requested map image in the map data memory area M (step s11).

The CPU determines whether or not the map data corresponding to the requested map image is already stored in the map data memory area M based on the retrieval result at step s11 (step s12). If the map data is stored in the map data memory area M, the CPU reads the map data from the map data memory area M (step s13) and displays the map image on the display based on the read map data (step s14).

If the CPU determines at step s12 that the map data corresponding to the requested map image is not stored in the map data memory area M, the CPU loads map data through the Internet I or from CD-ROM (step s15), stores the loaded map data in the map data memory area M (step s16) in a similar manner to that at step s4 in FIG. 2, and displays the map image based on the map data at step s14.

As described above, according to the information display method, the map data loaded from external into the information terminal T′ is written into the map data memory area M set in the hard disk HD for storage and a map image is displayed based on the stored map data, so that when the same map image is again displayed, the need for again loading the map data is eliminated, the map image is displayed rapidly, and image display is also produced smoothly as the scroll operation is performed. Further, it is made possible to reduce the communication cost for downloading the map data through the Internet I.

A data update program is built in the loader management program LP, whereby the information terminal T′ can be connected to the Internet I as the user's manual operation is performed or automatically every expiration of a set time period to update the map data stored in the map data memory area M to downloaded map data.

The map data stored in the map data memory area M can also be updated to the map data loaded from CD-ROM.

What is claimed is:

1. A method of displaying information read from external in an information terminal, the method comprising the steps of:
setting a storage area of information read from external in a storage section of the information terminal;
storing the information read from external in the information storage area;
when the information terminal is requested to display information, determining whether or not the information requested to be displayed is stored in the information storage area;
when the information requested to be displayed is stored in the information storage area, reading the information stored in the information storage area to display the information on the information terminal; and
when the information requested to be displayed is not stored in the information storage area, reading the information to be displayed from external to display the information read from external on the information terminal and to store the information read from external in the information storage area.

2. The method according to claim 1, wherein the information stored in the information storage area is information provided from an information providing site connected to the information terminal through a computer network.

3. The method according to claim 1, wherein the information stored in the information storage area is information read from a storage medium.

4. The method according to claim 1, wherein the information is stored in the information storage area together with date data indicating the storage date.

5. The method according to claim 1, wherein the information stored in the information storage area is updated to one of information provided from an information providing site connected to the information terminal through a computer network and information read from a storage medium.

6. The method according to claim 1 wherein the information stored in the information storage area is map data to display a map image.
